(19) United States
(12) Patent Application Publication
(10) Pub. No.: US 2018/0268738 A1
(43) Pub. Date: Sep. 20, 2018

(54) SYSTEMS AND METHODS FOR AUGMENTED REALITY-BASED SERVICE DELIVERY

(71) Applicant: MASTERCARD INTERNATIONAL INCORPORATED, Purchase, NY (US)

(72) Inventors: Matthew James Miller, Redding, CT (US); Jackson Hamburger, New York, NY (US); Louis Antonelli, New York, NY (US)

(21) Appl. No.: 15/925,298

(22) Filed: Mar. 19, 2018

Related U.S. Application Data
(60) Provisional application No. 62/473,565, filed on Mar. 20, 2017.

(51) Int. Cl. G09B 19/00; G06T 19/00; G02B 27/01; G06F 3/01

(52) U.S. Cl. CPC G09B 19/003; G06F 3/011; G02B 27/017; G06T 19/006

(57) ABSTRACT

An augmented reality (AR) computing device for generating computer-generated (CG) elements using an AR display is provided. The AR computing device is configured to receive a request from a first user of the AR display for a first CG element to be displayed on the AR display. The first CG element is a visual representation of at least one target physical movement. The AR computing device is also configured to cause the AR display to render the first CG element on the AR display. The AR computing device is further configured to receive a first movement input from the camera device representing a physical movement of the first user captured by the camera device, compare the first movement input to the first CG element, determine that the first movement input exceeds a predefined comparison threshold, and cause the AR display to display an alert to the first user.

### CROSS REFERENCE TO RELATED APPLICATIONS

This application claims the benefit of and priority to U.S. Provisional Patent Application Ser. No. 62/473,565, filed Mar. 20, 2017, the contents of which are hereby incorporated by reference in their entirety.

### BACKGROUND

This disclosure relates generally to application services delivered via augmented reality systems, and more specifically to methods and systems for providing augmented-reality based personal services to consumers of those services.

The term “augmented reality” (AR) generally refers to a view of a physical, real-world environment of a viewer where certain elements in the view (or AR view) are augmented by computer-generated sensory input, such as sound, video, or graphics data. The computer-generated (CG) elements may be purely computer-generated or generated using a real-world object that is in the viewer's physical environment or is remotely located from the viewer. Within the view, the CG elements appear to be superimposed onto the viewer's physical environment to create an augmented reality as distinct from the viewer's physical reality. In some implementations, the viewer will use an AR display device to see the AR view. AR display devices may include glasses, goggles, head-up displays (e.g., on a car windshield), or the like. Additionally, a viewer will often have one or more optical instruments, such as cameras, for recording or capturing images of the viewer and the viewer's environment. These cameras may be used to record the viewer's movements for later viewing or transmission as well.

Some known systems' use of AR is quite limited. For example, some known AR-using systems are limited in their ability to present CG elements that have been tailored specifically to the viewer. Some other known AR-using systems are unable to present CG elements that can be used by the viewer for a defined purpose (e.g., to mimic the CG element or to gain usable information from them). Some other known AR-using systems are unable to present continuously updated data from a remote source. For example, these known systems can only present preset CG elements and cannot update them in response to, for example, a remote object or person that is the source for generating the CG element(s). Other known AR-using systems are limited in the ability of a viewer to interact with the CG element, leading to a less engaging experience. For example, these systems do not provide the ability for a viewer to interact with a CG element such that the CG element updates its appearance or causes an update to the view in the viewer's AR display device.

In addition to AR systems, there are also computer systems that are virtual reality (VR) based computer systems. VR-based systems are different from AR systems that the user's view is entirely computer-generated. VR-based systems may cause safety concerns in certain activities (such as personal training) where the total immersion in a virtual reality environment may decrease situational awareness and cause injury.

### BRIEF DESCRIPTION

In one aspect, an augmented reality (AR) computing device for generating computer-generated (CG) elements using an AR display is provided. The AR computing device is configured to receive a request from a first user of the AR display device for a first CG element to be displayed on the AR display device. The first CG element is a visual representation of at least one target physical movement. The AR computing device is also configured to cause the AR display device to render the first CG element on the AR display device. The AR computing device is further configured to receive a first movement input from the camera device representing a physical movement of the first user captured by the camera device, compare the first movement input to the first CG element, determine that the first movement input exceeds a predefined comparison threshold, and cause the AR display device to display an alert on the display surface to alert the first user.

In another aspect, a method of generating computer-generated (CG) elements using an augmented reality (AR) computing device is provided. The AR computing device is communicatively coupled to a camera device and an AR display device operated by a first user. The method includes receiving a request from the first user for a first CG element to be displayed on the AR display device. The first CG element is a visual representation of at least one target physical movement. The method also includes causing the AR display device to render the first CG element on a display surface of the AR display device, receiving a first movement input from the camera device representing a physical movement of the first user captured by the camera device, comparing the first movement input to the first CG element, determining, based on the comparison, that the first movement input exceeds a predefined comparison threshold, and causing the AR display device to display an alert on the display surface to alert the first user based on the determination.

In yet another aspect, a non-transitory computer readable medium that includes computer executable instructions for generating computer-generated (CG) elements using an augmented reality (AR) computing device is provided. The AR computing device is communicatively coupled to an AR display device operated by a first user and a camera device. When executed by the AR computing device, the computer executable instructions cause the AR computing device to receive a request from the first user for a first CG element to be displayed on the AR display device. The first CG element is a visual representation of at least one target physical movement. The computer executable instructions also cause the AR computing device to cause the AR display device to render the first CG element on a display surface of the AR display device. The computer executable instructions further cause the AR computing device to receive a first movement input from the camera device representing a physical movement of the first user captured by the camera device, compare the first movement input to the first CG element, determine, based on the comparison, that the first movement input exceeds a predefined comparison threshold, and cause the AR display device to display an alert on the display surface to alert the first user based on the determination.

### BRIEF DESCRIPTION OF THE DRAWINGS

FIGS. 1-8 show example embodiments of the methods and systems described herein.

FIG. 1 is a simplified block diagram of an example augmented reality (AR) environment, in which a variety of computing devices are communicatively coupled to each other via a plurality of network connections.

FIG. 2 illustrates an example configuration of an AR display device (shown in FIG. 1) configured to display data, such as CG elements, during an AR-based service delivery interaction.

FIG. 3 illustrates an example configuration of an AR computing device such as the AR computing device shown in FIG. 1.

FIG. 4 illustrates an augmented reality (AR) view that a viewer may receive via, for example the AR display device shown in FIG. 1 as generated by the AR computing device shown in FIG. 1.

FIG. 5 illustrates an example AR environment where the AR computing device delivers AR-based services to a client in a client environment and a trainer in a trainer environment.

FIG. 6 illustrates an example AR environment where a client is able to interact with one or more purely software-based CG elements generated by the AR computing device.

FIG. 7 describes a method flow used by the AR computing device to deliver particular AR-based services to a viewer in conjunction with the AR display device.

FIG. 8 shows an example configuration of a database within a computer device, along with other related computer components, that may be used to deliver AR-based services to a viewer.

Like numbers in the Figures indicate the same or functionally similar components.

### DETAILED DESCRIPTION

The systems and methods described herein relate generally to application services delivered via augmented reality systems. More specifically, the systems and methods described herein include an augmented reality (AR) computing device that provides augmented-reality based services to consumers of those services. An overview of example embodiments is provided herein. The following paragraphs use the example of a personal training service to illustrate the example embodiments disclosed herein. Although much of this description relates to the use of the AR system in the context of personal training, it should be understood that the systems and methods described herein are not limited to such a use only. The systems and methods described herein could be used in many other service-based applications as well.

In one example embodiment, a viewer (also referred to herein as a user, a trainee, or a client) uses an augmented reality (AR) display device. The AR display device may be a pair of goggles, a pair of glasses, one or more contact lenses, a handheld device or screen, a fixed screen (such as a vehicle windshield or other surface), or the like. More generally, the AR display device can be any surface that a viewer can look at to see the viewer's physical environment but that also enables the viewer to view certain computer-generated (CG) elements superimposed onto the viewer's view of the physical environment. These CG elements may appear two-dimensional or three-dimensional. As an example, the CG element may be a three-dimensional (3D) rendering. In the example embodiment, the AR computing device generates these CG elements and transmits them to the AR display device for the viewer to view. The AR display device will also have embedded or communicatively coupled input/output devices to enable the viewer to interact with the AR display device. For example, the AR display device may have a camera device embedded or attached, enabling the AR display device to capture and record images directly. As another example, the AR display device will include a microphone to receive voice commands, a speaker to transmit audio outputs, or the like. In a related embodiment, the AR display device can also be an AR computing device (i.e., the AR display device may generate some or all CG elements itself as well).

At least three different embodiments are contemplated herein. In the embodiments described herein, it is to be understood that while the generated CG elements may appear to move in a localized space, the CG elements do not travel in proportion to the viewer. In other words, it is to be understood that the generated CG elements remain in a fixed position (even if performing localized movements) such that if a viewer walks “closer” to a CG element, the CG element does not travel further away in proportion. Relatedly, the AR computing device is configured to automatically adjust the appearance of the CG element based on the viewer's movements. For example, if the viewer moves toward the CG element, the CG element will appear to become larger. More specifically, the AR computing device uses the location of the AR display device (worn or used by the viewer) in order to automatically adjust the CG element. This enables the viewer to review the CG element carefully, such as by inspecting it closely or by walking around it and/or reviewing the CG element from various angles.

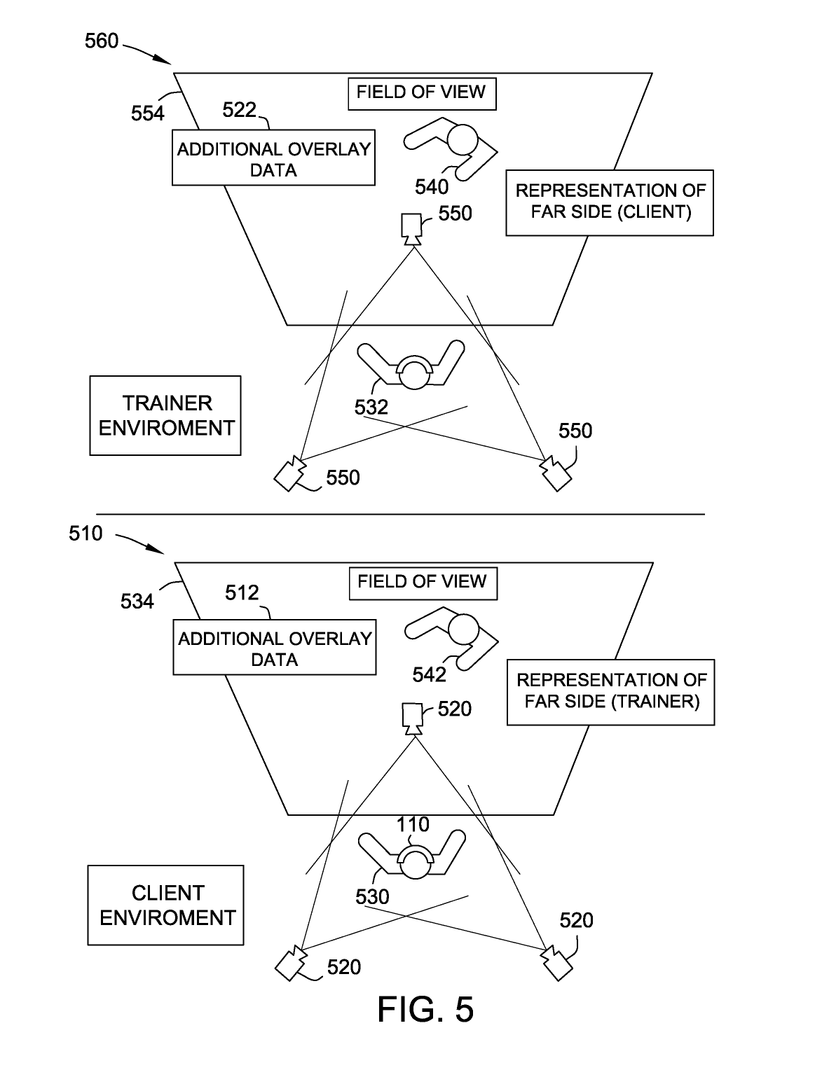

In a first example embodiment, the AR computing device uses a remote object or person as a template to generate the CG element(s), which provide a visual representation of at least one target physical movement for the user to emulate. For example, a personal trainer may use cameras to capture imagery of the personal trainer's movements that are then used by the AR computing device to generate a CG element representing the personal trainer. This CG element (or elements) is then rendered on the AR display device that is used by a trainee viewing the CG element remotely from the trainer. For example, the CG element may be three-dimensional (3D). The trainee may be able to “walk around” the CG element to view the trainer's 3D appearance from different angles. Relatedly, the AR computing device is configured to display the CG element on the AR display device from a live input from the personal trainer. The AR computing device is also configured to receive the live input and present a CG element as a recording for later viewing to the trainee. In one example, the CG elements are generated from part of a physical object (e.g., a trainer's body). Instead of the full body of the trainer, the AR computing device may present part of the body (e.g., just the trainer's arms for an arm exercise) in order to isolate the CG element or elements that are most relevant to the trainee. Similarly, a trainer can also be a viewer in that the trainer's AR display device will display to the trainer a CG element representing the trainee while the trainee performs exercise movements. This first example embodiment is later described with respect to FIG. 5 that represents both a client environment and a trainer environment in which each viewer (client and trainer) can view a CG element representing the other viewer.

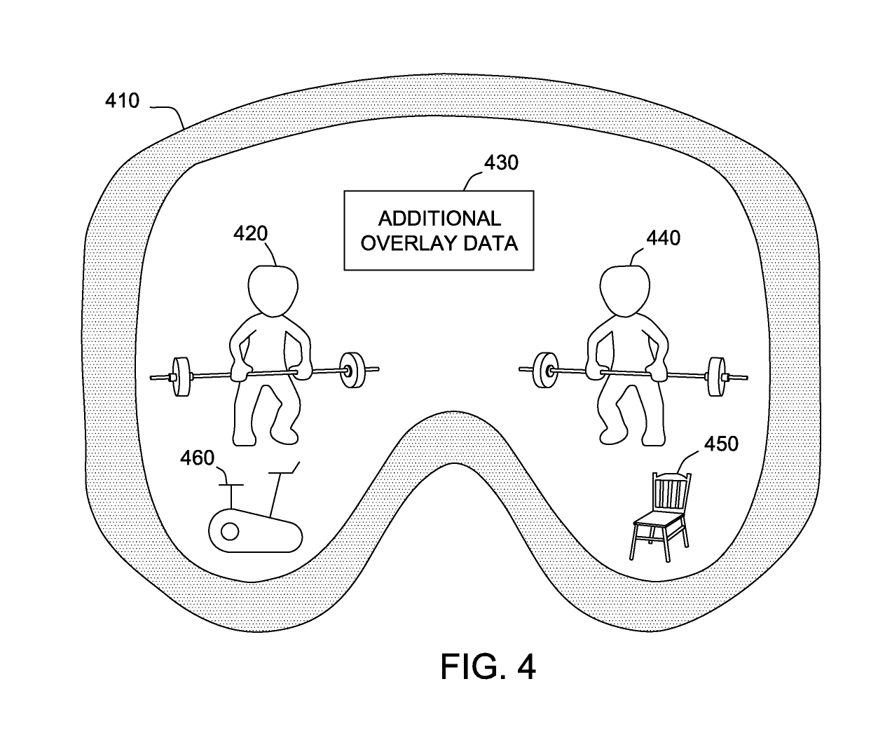

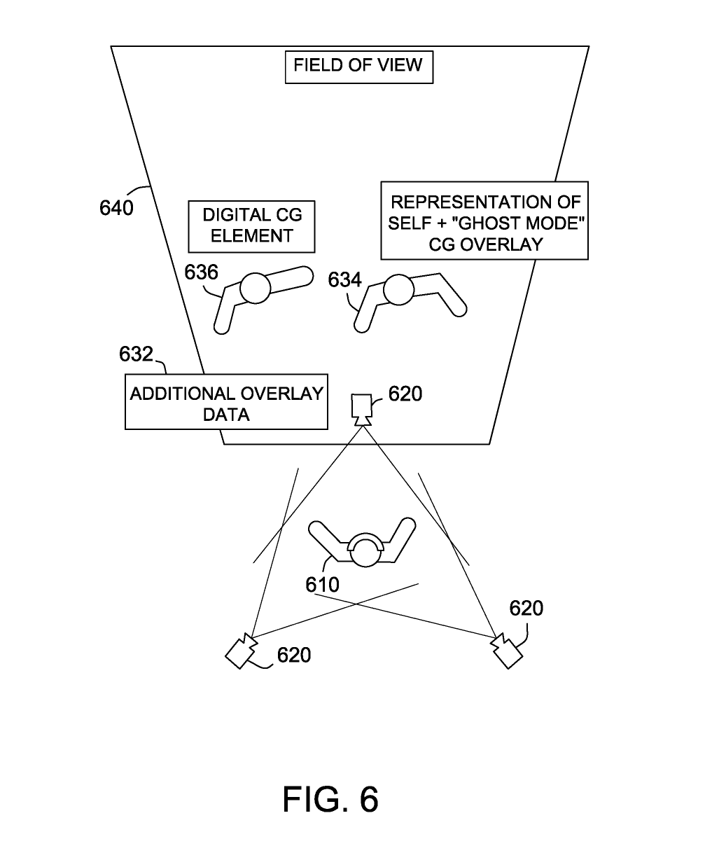

In a second example embodiment, the AR computing device uses the viewer himself or herself to generate the CG element. For example, the AR computing device may generate a full body CG element that represents the viewer himself or herself situated in 3D space. As in the first example embodiment, the viewer may have one or more cameras to capture imagery of the viewer. Similarly, as in the first example embodiment, the AR computing device enables the viewer to view a 3D CG element (that represents the viewer) from a variety of angles. This second example embodiment is later described with respect to FIGS. 4 and 6 that represent a “ghost” CG element representing the viewer himself or herself. For example, the ghost CG element is a representation of the viewer displaying on the AR display device. This enables the viewer to review the viewer's own movement from different angles.

In a third example embodiment, the AR computing device generates purely software-based CG elements, which provide a visual representation of at least one target physical movement for the user to emulate. More specifically, these software-based CG elements may be generated without having originated specifically from a physical object that was (or is currently) being imaged using cameras. For example, a viewer may wish to do an exercise routine, such as biceps curls, that requires isolated movement and observation of certain muscle groups (e.g., the arm muscles). In such a case, the AR computing device is configured to generate a CG element that represents the proper form for biceps curls. For example, two CG elements may be generated that appear to be two arms performing biceps curls. The viewer can view these CG elements and determine whether the viewer is performing the correct exercise. In a related embodiment, these CG elements may be derived using programmatic inputs (e.g., from a trainer). As used herein, programmatic inputs refer to input data that does not derive from captured images. For example, a trainer may provide trainer configuration data to the AR computing device to help the AR computing device generate the CG elements. For example, programmatic data may include purely mathematical values such as, but not limited to, number of repetitions in an exercise, arm size of the user for scaling the CG element, target arm movement angles, or the like. Although the example relates to an exercise involving the arm, it should be understood that other body movements involving legs, torso, head, and any combination thereof are also contemplated, with programmatic inputs including other suitable body dimensions of the user for scaling purposes and other suitable target movement parameters, such as target angles and/or positions of body parts. This third example embodiment is later described with respect to FIG. 6 that illustrates the viewer's ability to “step into” a digital CG element.

The abovementioned example embodiments are described in greater detail below.

The AR computing device runs specifically configured software (including computer-executable instructions) to generate CG elements using a variety of sources. In one embodiment, the AR computing device generates CG elements using a physical object. For example, the AR computing device receives images or video of a physical object and uses those to generate a CG element that represents that physical object. The AR computing device then renders it on the viewer's AR display device as superimposed on the viewer's physical environment view. In this embodiment, the physical object is remote from the viewer. For example, the physical object may be a person that is in another location that is different from the viewer's location. As a more specific example, a trainer may perform an exercise routine and have one or more cameras capture the trainer's movements. Images from the cameras are transmitted to the AR computing device. The AR computing device will then generate a CG element in real time (representing, for example, the trainer's movements) and transmit it to the viewer's AR display device. The result will be that the viewer sees the trainer's movements as a CG element on the AR display device as superimposed on the viewer's physical environment.

In addition to a view of the viewer's physical environment and the CG elements, the AR display device also displays additional overlay data that is generated by the AR computing device (or may be generated by the AR display device itself). Additional overlay data may be displayed using an assigned portion of the total display area viewable by the viewer through the AR display device. This assigned portion is referred to herein as the additional overlay data display. Additional overlay data, as defined herein, includes data regarding the viewer, regarding remote objects or persons, regarding the viewer's activity, and regarding the AR computing device and AR display device as well. For example, in the personal training scenario, the additional overlay data will include details of the viewer's current and prior exercise routines (e.g., time, sets, repetitions, distance, weights, success scores, etc.). Additional overlay data may also display other information such as battery life, volume, date, current time, or the like. Additional overlay data also provides the viewer with the ability to make purchases or changes to a viewer account. For example, the AR computing device will transmit to the AR display device details of the viewer's personal training account (e.g., exercise routines purchased, time remaining, payment account details, etc.). In one embodiment, the AR computing device transmits this data and renders the additional overlay data as a CG element that enables the viewer to interact with the additional overlay data. For example, the additional overlay data presents itself as a 2D or 3D menu screen, including items such as “Select Exercise.” The viewer gestures toward the part of the menu that includes “Select Exercise,” such as by swiping through that space or pressing on it as if it were a button. The viewer's gesture causes the AR computing device to update the menu within the additional overlay data (e.g., to present a list of exercises). The AR computing device also configures the AR display device to be able to receive specific eye movements or eye gestures to control the additional overlay data. For example, detecting a sustained focus of the viewer's eyes on the additional overlay data display can lead to it being activated for further commands by the viewer.

In another embodiment, the AR computing device generates the CG element using a recording of the physical object (and/or person) from an earlier point in time, prior to the user's activation of the training program. For example, the trainer mentioned above may record the routine via cameras in the trainer's location, and have the cameras transmit the images to the AR computing device for later rendering on the AR computing device in response to a subsequent request by the user.

In another embodiment, the AR computing device generates CG elements that represent the viewer. For example, the viewer may have one or more cameras in the viewer's physical environment (e.g., the viewer's living room). These cameras capture images of the viewer and transmit them to the AR computing device. As mentioned earlier, the AR computing device then generates CG elements that represent the viewer and render them on the AR display device being used by the viewer. For example, the viewer may be executing a workout routine (e.g., a series of squats). The AR computing device renders the viewer's movements on the AR display device, such as a three-dimensional CG element that appears on the AR display device resembling the viewer and the viewer's movements. This enables the viewer to view (and review) his or her movements in three-dimensional space during the exercise routine. More specifically, the viewer can initiate a recording of the CG element as it is being generated from the viewer's movements. The viewer can interact with the additional overlay data display to replay, pause, rewind, forward, or perform other functions related to the recording.

For example, the viewer can walk around the three-dimensional CG element representing the viewer. As a result, the viewer will be able to look at a rear view of the viewer while doing the exercise, which may not be possible when doing the exercise in front of a mirror. This improves the efficacy of the exercise because the viewer is able to review his or her “form.” Form, as used herein, is a set of movement patterns that represents a more productive or more efficient way of performing an exercise or workout. Proper form also promotes safety and reduces the risk of injury from improperly performing an exercise. For example, the proper form for a squat exercise will include keeping the lower back neutral while performing the squat. The AR computing device enables the viewer to review the viewer's own lower back while performing a squat. More specifically, the AR computing device generates the CG element representing the viewer that the viewer can then walk “behind” and see the viewer's own lower back while squatting. The viewer is also able to rotate the CG element appropriately using the additional overlay data display on the AR display device. As mentioned above, the AR computing device is configured to render a CG element generated from a trainer's live or recorded imagery as well. As in the case of a CG element rendered from the viewer's own movements, the viewer is able to walk around or behind the trainer's CG element(s) as well to review the trainer's movements and improve the viewer's own form.

In a related embodiment, the AR computing device is configured to generate a viewer CG element (i.e., one generated using the viewer's image data) and then superimpose an optimized CG element onto the viewer CG element. In this embodiment, the AR computing device gives the viewer the ability to perform, for example, an exercise routine and view a comparison of the viewer's CG element to an optimized version of the exercise routine. For example,

The AR computing device is also configured to enable the viewer to interact with the CG element. For example, the viewer is given the ability to adjust the CG element using specific gestures. As a more specific example, the AR computing device is configured to enable the viewer to select a “adjust CG element” mode. When in this mode, the AR computing device receives adjustment inputs from the viewer (e.g., by capturing the viewer's own movements) and adjusts the CG element accordingly in response to detecting a predefined motion of the viewer with respect to the CG element. For example, in this mode, the viewer may surround the CG element with his or her hands and attempt to shrink or expand the CG element in 3D space. The AR computing device adjusts the size of the CG element accordingly. For another example, the predefined motion includes a spatial overlap of the viewer's hand with a particular region of the CG element. Other adjustments, such as moving or turning the CG element or changing its color or appearance may also be provided.

The AR computing device is configured to provide performance feedback to the viewer as the viewer is performing an exercise routine. More specifically, the AR computing device accomplishes this by tracking the viewer's movements using the viewer's cameras and comparing these movements to those represented by the generated CG element. For example, the CG element represents a set of five biceps curls. The viewer can perform the set of five biceps curls while following the CG element and then receive feedback on how well the viewer performed the exercise. For example, the AR computing device is configured to provide a success score to the viewer. The success score is generated by executing one or more image processing techniques (or algorithms) that can compare the CG element images with those generated from the viewer. The image processing techniques will provide a percentage or other score to represent, for example, a degree of congruence between the CG element and the viewer's movements (or stationary state).

In a related embodiment, the AR computing device gives the viewer the ability to “step into” the CG element and compare the viewer in physical space to the CG element. This enables the viewer to, for example, visually determine a degree of congruence between the viewer and the CG element. As in the third example embodiment described above, the AR computing device generates a purely software-based CG element. The viewer then physically moves toward the generated CG element as displayed on the AR display device and enters the same three-dimensional space as the CG element. In other words, the viewer “steps into” this CG element. For example, assume that the CG element is an arm performing a biceps curl. Accordingly, the viewer places the viewer's arm in the same space as the CG element and begins to perform a biceps curl. The CG element may also display an additional object such as a dumbbell or other weight to assist the viewer in aligning with the CG element. As the viewer performs the biceps curl, the AR computing device is configured to review images captured from the viewer's movements and compare them to the CG element. In one embodiment, the viewer sees the success score or other metric displayed on the AR display device that shows how closely the viewer's movement matches that of the CG element. In one embodiment, the AR computing device provides an audio and/or visual alert when the determines that the viewer's movement matches the CG element based on a predefined parameter (e.g., a threshold of 90% or a confidence interval or 90%). For example, the AR computing device will cause the AR display device to display an alert, or change the color or appearance of the CG element, or cause the AR display device or some other device to play a sound, or the like. Although the example discussed above relates to an exercise involving arm movement, it should be understood that other body movements involving legs, torso, head, and any combination thereof are also contemplated.

As mentioned above, the AR computing device receives data from the viewer using one or more cameras or other optical instruments that are in the same physical space as the viewer. In one embodiment, the viewer initializes one or more cameras by placing them at designated positions or angles within, for example, a room. When activated, these cameras define a viewable zone within the viewer's room. The viewable zone is delimited as a three-dimensional space within which CG elements are renderable and within which viewer movement (and other objects) can be registered. In one embodiment, the viewer enters the room, activates the cameras and allows each camera to register the other cameras, and additional objects in the room. As used herein, these additional objects are of two types, AR objects and non-AR objects. AR objects include the form of the viewer and certain other objects that the viewer may wish to register as part of the service or activity for which the viewer is using the AR computing device. For example, the viewer may wish to register a set of weights, a stationary bicycle, a jump rope, a treadmill, or some other exercise-related object with the cameras. Once registered, these objects become AR objects and their imagery is captured by the cameras to facilitate the viewer's activity.

For example, the viewer uses the AR computing device during a weightlifting activity. Accordingly, the viewer's weights are registered by the cameras and can be evaluated for positioning and overall form when the viewer “steps into” a CG element, as described above. Similarly, a trainer will use the trainer's cameras to register specific objects (e.g., the trainer's weights). In another example, a stationary bicycle or treadmill may be registered with the one or more cameras. In this example, the cameras record the movements of the bicycle or treadmill along with the viewer's movements in order to determine certain quantities. For example, the AR computing device will observe a viewer's bike pace, running gait, speed, pedal positioning, pronation, or the like. The AR computing device will compare these to preferred quantities or movements (e.g., based on viewer preferences or trainer inputs) and provide feedback using the additional overlay data displayed on the AR display device. Additionally, the AR computing device will measure the viewer's congruence with any generated CG elements as described above. For example, the viewer may “step into” an ideal runner's gait and run at a certain pace on a treadmill. The AR computing device will compare the viewer's gait on the treadmill to the ideal gait and provide feedback (e.g., the success score).

The technical problems addressed by this system include at least one of: (i) safety pitfalls posed by virtual reality systems due to complete immersion in a virtual environment, (ii) inability of known systems to generate partial CG elements for a viewer to focus on, for example, a specific body part, (iii) inability of known systems to generate purely software-based CG elements that are usable for mimicking and determining congruence to the generated CG element, and (iv) inability of known systems to enable a viewer to follow a generated CG element and receive feedback on the viewer's performance.

The methods and systems described herein may be implemented using computer programming or engineering techniques including computer software, firmware, hardware, or any combination or subset thereof, wherein the technical effects may be achieved by a) receiving a request from a first user of the AR display device for a first CG element to be displayed on the AR display device, the first CG element being a visual representation of at least one target physical movement, b) causing the AR display device to render the first CG element on the AR display device, c) receiving a first movement input from the camera device representing a physical movement of the first user captured by the camera device, d) comparing the first movement input to the first CG element, e) determining that the first movement input exceeds a predefined comparison threshold, and f) causing the AR display device to display an alert on the display surface to alert the viewer.

The resulting technical benefits achieved by this system include at least one of: (i) ability of the AR computing device to produce a more lifelike representation of a service provider to a viewer using a CG element generated from a service provider, (ii) enabling the viewer to manipulate the CG element using physical or eye movements, leading to a more engaging experience for the viewer, (iii) ability of the AR computing device to filter out part of a CG element in order to generate a specific partial CG element that can focus on part of a physical object thereby facilitating faster data transmission of a smaller amount of data, (iv) generation of software-based CG elements that do not require a physical object for rendering, thereby enabling a greater variety of CG elements to be generated, (v) ability to track a viewer's movements relative to a generated CG element and determine the viewer's congruence to the CG element, enabling performance feedback to be provided to the viewer, (vi) ability to compare a viewer's movement to a reference movement (e.g., a CG element generated from another person or even purely software-generated) in order to generate performance feedback and scoring for the viewer, specifically by comparing the viewer or the viewer's CG element or other reference CG elements using one or more image processing techniques, algorithms, or the like, (vii) ability to generate statistical analysis from historical data for the viewer, enabling the viewer to review current performance against past performance, such analysis based on analysis of current and stored imagery as well as additional statistics and/or data points captured for the viewer, and (viii) improved AR system experiences because a viewer can safely interact with a CG element without the safety concerns posed by virtual reality systems.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable storage medium. In an example embodiment, the system is executed on a single computer system, without requiring a connection to a server computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application in industrial, commercial, and academic applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

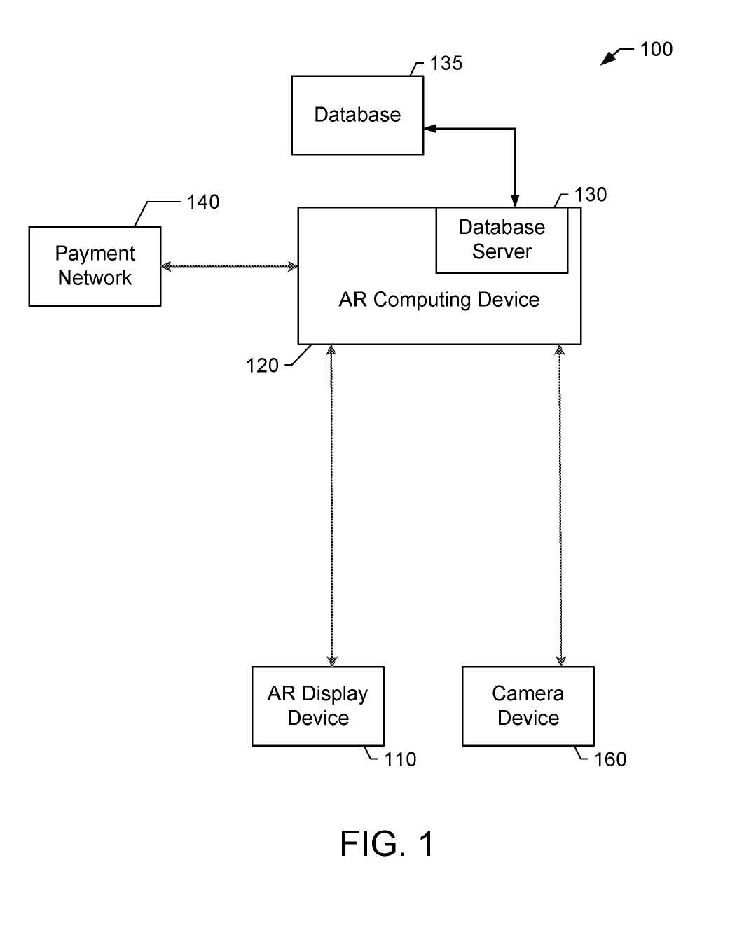

FIG. 1 is a simplified block diagram of an example augmented reality (AR) environment 100, in which a variety of computing devices are communicatively coupled to each other via a plurality of network connections. These network connections may be Internet, LAN/WAN, Bluetooth™, Wi-Fi, or other connections capable of transmitting data across computing devices. AR environment 100 includes augmented reality (AR) computing device 120, AR display device 110, and database 135. AR computing device 120 may be a service provider computing device, a network of multiple computer devices, a virtual computing device, or the like. AR computing device 120 is connected to at least one payment network 140. Payment network 140 will transmit and receive payment or account data for a viewer that is operating AR display device 110 as described above. AR computing device 120 may be in communication with other systems and/or computing devices. In the example embodiment, AR computing device 120 is in communication with AR display device 110. In the example embodiment, AR computing device 120 receives and transmits data to AR display device 110 and camera device 160.

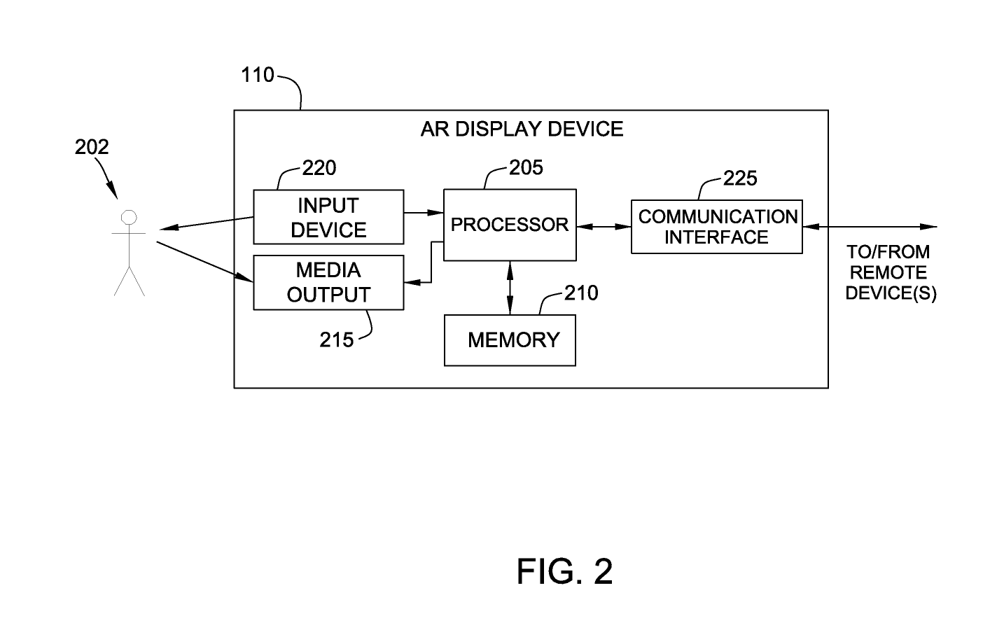

Database server 130 connects AR computing device 120 to database 135, which contains information on a variety of matters, as described below in greater detail. In one embodiment, database 135 is stored on AR computing device 120 and can be accessed by potential users of AR computing device 120. In an alternative embodiment, database 135 is stored remotely from AR computing device 120 and may be non-centralized. Database 135 may include a single database having separated sections or partitions or may include multiple databases, each being separate from each other. Database 135 is in communication with AR display device 110 via AR computing device 120 and may store data associated with an account of user 202 (shown in FIG. 2).

AR display device 110 is configured to receive data from a viewer of AR display device 110 (similar to the viewer described earlier). The viewer may input data via the viewer's hand gestures, and/or the viewer's eye movement. AR display device 110 is further configured to receive image data for the viewer that is generated from camera device 160. As mentioned above, one or more camera devices 160 will be placed in proximity to the viewer and, when activated, capture image data for the viewer. This image data is transmitted to AR computing device 120 in order for AR computing device to render a CG element derived from the image data. For example, image data of a first viewer (e.g., a trainee) is transmitted to a second viewer (e.g., a trainer) as a CG element rendering the first viewer.

FIG. 2 illustrates an example configuration of an AR display device 110 (shown in FIG. 1) configured to display data, such as CG elements. In the example embodiment, AR display device 110 includes a processor 205 for executing instructions. In some embodiments, executable instructions are stored in a memory 210. Processor 205 may include one or more processing units, for example, a multi-core configuration. Memory 210 is any device allowing information such as executable instructions and/or written works to be stored and retrieved. Memory 210 may include one or more computer readable media.

AR display device 110 also includes at least one media output component 215 for presenting information to user 202. Media output component 215 is any component capable of conveying information to user 202. In the example embodiment, media output component may be, for example, a see-through display or other screen. In some embodiments, media output component 215 includes an output adapter such as a video adapter and/or an audio adapter. An output adapter is operatively coupled to processor 205 and operatively connectable to an output device such as a display device, a liquid crystal display (LCD), organic light emitting diode (OLED) display, or “electronic ink” display, or an audio output device, a speaker or headphones.

In some embodiments, AR display device 110 includes an input device 220 for receiving input from user 202. Input device 220 may include, for example, a keyboard, a pointing device, a mouse, a stylus, a touch sensitive panel, a touch pad, a touch screen, a gyroscope, an accelerometer, a position detector, an audio input device, a fingerprint reader/scanner, a palm print reader/scanner, a iris reader/scanner, a retina reader/scanner, a profile scanner, a hand gesture reader/scanner, or the like. A single component, such as a touch screen, may function as both an output device of media output component 215 and input device 220. A single component such as a touch screen may function as both an output device of media output component 215 and input device 220. AR display device 110 may also include a communication interface 225, which is communicatively connectable to a remote device such as AR computing device 120 (shown in FIG. 1). Communication interface 225 may include, for example, a wired or wireless network adapter or a wireless data transceiver for use with a mobile phone network, Global System for Mobile communications (GSM), 2G, or other mobile data network or Worldwide Interoperability for Microwave Access (WIMAX).

Stored in memory 210 are, for example, computer readable instructions for providing a user interface to user 202 via media output component 215 and, optionally, receiving and processing input from input device 220. A user interface may include, among other possibilities, a web browser and client application. Web browsers enable users, such as user 202, to display and interact with media and other information typically embedded on a web page or a website from AR computing device 120. A client application allows user 202 to interact with an AR computing device application from AR computing device 120.

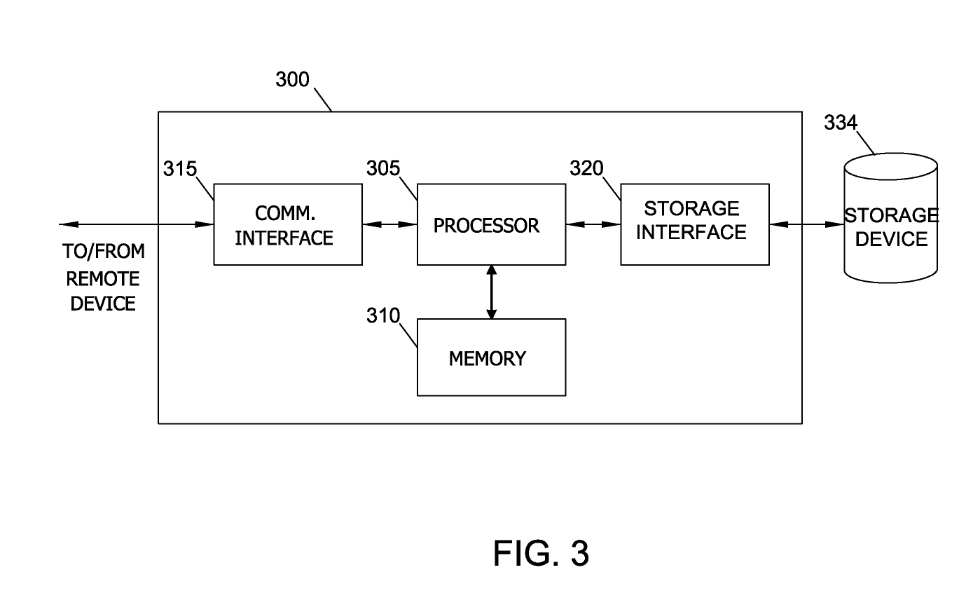

FIG. 3 illustrates an example configuration of an AR computing device 300 such as the AR computing device 120 (shown in FIG. 1).

AR computing device 300 includes a processor 305 for executing instructions. Instructions may be stored in a memory 310, for example. Processor 305 may include one or more processing units (e.g., in a multi-core configuration) for executing instructions. The instructions may be executed within a variety of different operating systems on the AR computing device 300, such as UNIX, LINUX, Microsoft Windows®, etc. More specifically, the instructions may cause various data manipulations on data stored in storage device 334 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that AR computing device 300 is capable of communicating with a remote device, such as AR display device 110, another user system, and/or another AR computing device 300. For example, communication interface 315 may also receive communications from payment network 140 via the Internet, as illustrated in FIG. 1.

Processor 305 may also be operatively coupled to a storage device 334. Storage device 334 is any computer-operated hardware suitable for storing and/or retrieving data. In some embodiments, storage device 334 is integrated in AR computing device 300. In other embodiments, storage device 334 is external to AR computing device 300 and is similar to database 130 (shown in FIG. 1). For example, AR computing device 300 may include one or more hard disk drives as storage device 334. In other embodiments, storage device 334 is external to AR computing device 300 and may be accessed by a plurality of AR computing devices 300. For example, storage device 334 may include multiple storage units such as hard disks or solid state disks in a redundant array of inexpensive disks (RAID) configuration. Storage device 334 may include a storage area network (SAN) and/or a network attached storage (NAS) system.

In some embodiments, processor 305 is operatively coupled to storage device 334 via a storage interface 320. Storage interface 320 is any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

Memory 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

FIG. 4 illustrates an augmented reality (AR) view that a viewer may receive via, for example AR display device 110 (shown in FIG. 1) as generated by AR computing device 120 (shown in FIG. 1). As shown, FIG. 4 includes AR display device 410 (similar to AR display device 110 shown in FIG. 1). AR display device 410 displays an AR view that includes CG element 420, additional overlay data display 430, CG ghost element 440, physical object 450, and AR-capable physical object 460.

As described above, AR computing device 120 will generate one or more CG elements according to the service or routine requested by the viewer. In one embodiment, AR computing device 120 generates CG element 420 using image data captured from a remote user (such as a trainer). In another embodiment, AR computing device 120 generates CG ghost element 440 using image data captured from the viewer himself or herself. As described earlier, CG ghost element 440 is generated using the viewer in order to enable the viewer to interact with a rendering of the viewer in real time and thereby review the viewer's own movements from various angles.

AR computing device 120 also generates additional overlay data display 430 and renders it on AR display device 410. Additional overlay data display 430 includes various data points relating to the viewer's activity. For example, where the viewer is performing an exercise routine, additional overlay data display 430 may include data such as exercise date/time, sets, repetitions, weight, intensity, resistance level, or the like. Secondary devices (e.g., a heart rate monitor or step counter) may transmit additional data to AR computing device 120 such that AR computing device 120 will display this additional data (e.g., heart rate, pace, step count, etc.) on AR display device 410 using additional overlay data display 430

As described above, AR display device 410 may be a see-through display that displays physical objects in the viewer's physical environment as well, such as physical object 450 (e.g., a chair). In addition, there may be other physical objects in the viewer's physical environment, such as AR-capable physical object 460. As described above, AR-capable physical object 460 may be an object that enables overlay of CG elements in order for the viewer to perform an activity or routine. For example, AR-capable physical object 460 may be an AR-capable stationary bike that is capable of interacting with AR computing device 120. Accordingly, AR computing device 120 registers AR-capable physical object 460 (using input from, for example, camera devices 160 shown in FIG. 1) and overlays CG elements on AR-capable physical object 460. For example, where AR-capable physical object 460 is a stationary bike, AR computing device 120 may overlay knobs, screens, or buttons on the stationary bike to enable the viewer to control settings on the stationary bike. AR computing device 120 may overlay layers on the stationary bike's pedals to record movements of the viewer on the bike, or the like.

FIG. 5 illustrates an example AR environment that includes two subsidiary environments, a client environment 510 and a trainer environment 560. The example embodiment illustrated using FIG. 5 involves a trainer that is providing personal services (e.g., one on one exercise training) to a client. Client environment 510 includes client 530 wearing AR display device 110. Client environment 510 also includes one or more cameras 520 (similar to camera device 160 shown in FIG. 1). Client environment 510 also displays a field of view 534 that represents a view by client 530 as seen through AR display device 110 and similar to that shown in FIG. 4. Field of view 534 includes CG element 542 that represents trainer 532 in the trainer's physical environment. Field of view 534 also includes additional overlay data display 512 (similar to additional overlay data display 430 shown in FIG. 4).

Trainer environment 560 also includes one or more cameras 550 (similar to camera device 160 shown in FIG. 1). Trainer environment 560 also displays a field of view 554 that represents trainer 532's view as seen through AR display device 110 and similar to that shown in FIG. 4. Field of view 554 includes CG element 540 that represents client 530 in the client's physical environment. Field of view 554 also includes additional overlay data display 522 (similar to additional overlay data display 430 shown in FIG. 4).

As described earlier, client 530 will see trainer 532 rendered as CG element 542 within field of view 534 of client 530. Client 530 will use CG element 542 to perform, for example, an exercise routine. More specifically, client 530 will follow the movements made by CG element 542 in order to perform the exercise routine. Additional overlay data display 512 will include exercise routine data and other data to facilitate the routine of client 530. Similarly, trainer 532 can view client 530 using CG element 540 and review performance of client 530 and provide feedback.

FIG. 6 illustrates an example AR environment where a client 610 (similar to client 530 as described in FIG. 5) is able to interact with one or more purely software-based CG elements. As shown, FIG. 6 includes client 610 for whom cameras 620 are capturing and recording images. Cameras 620 transmit the recorded imagery to AR computing device 120 (shown in FIG. 1). AR computing device 120 in turn uses the received imagery to generate CG element 634. CG element 634 is similar to CG ghost element 440. CG element 634 is displayed within a field of view 640. More specifically, CG element 634 represents the viewer as a 3D CG element and enables the viewer to review the viewer's own movements in real time and in three-dimensional space.

Additionally, AR computing device 120 also generates digital CG element 636 and displays it within field of view 640. Digital CG element 636 is generated without image input from the viewer or a remote user (e.g., a trainer). Rather, digital CG element 636 is generated using programmatic inputs that may or may not be received from a remote user. For example, a trainer may use computer graphics software to draw the ideal form for an exercise and this drawing may be used to generate digital CG element 636. AR computing device also generates an additional overlay data display 632 (similar to additional overlay data display 430 shown in FIG. 4).

In a related embodiment, AR computing device 120 gives client 610 the ability to “step into” Digital CG element 636 and compare client 610 in physical space to digital CG element 636. This enables client 610 to, for example, visually determine a degree of congruence between client 610 and digital CG element 636. As in the third example embodiment described above, AR computing device 120 generates a purely software-based CG element. Client 610 then physically moves toward the generated CG element as displayed on the AR display device and enters the same three-dimensional space as digital CG element 636. In other words, client 610 “steps into” this CG element. For example, assume that digital CG element 636 is an arm performing a biceps curl. Accordingly, client 610 places his or her arm in the same space as digital CG element 636 and begins to perform a biceps curl. Digital CG element 636 may also display an additional object such as a dumbbell or other weight to assist client 610 in aligning with digital CG element 636. As client 610 performs the biceps curl, AR computing device 120 is configured to review images captured from movements of client 610 and compare them to digital CG element 636. In one embodiment, client 610 sees the success score or other metric displayed on the AR display device that shows how closely movement of client 610 matches that of digital CG element 636. In one embodiment, AR computing device 120 provides an audio and/or visual alert when AR computing device 120 determines that movement of client 610 matches digital CG element 636 based on a predefined parameter (e.g., a threshold of 90% or a confidence interval or 90%). For example, AR computing device 120 will cause the AR display device to display an alert, or change the color or appearance of digital CG element 636, or cause the AR display device or some other device to play a sound, or the like.

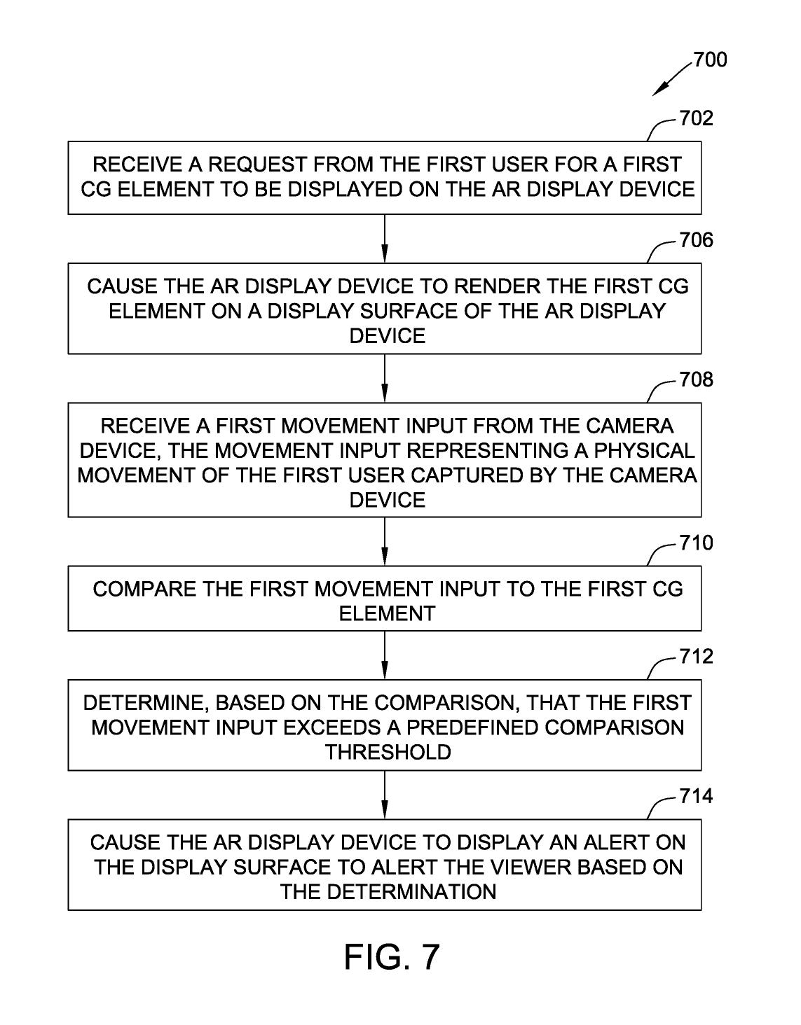

FIG. 7 describes a method flow 700 by which the AR computing device delivers AR-based services to a user. As shown in FIG. 7, at 702 the AR computing device receives a request from the first user for a first CG element to be displayed on the AR display device. The first CG element is a visual representation of at least one target physical movement. The AR computing device causes 706 the AR display device to render the first CG element on a display surface of the AR display device. The AR computing device receives 708 a first movement input from the camera device, the movement input representing a physical movement of the first user captured by the camera device. The AR computing device compares 710 the first movement input to the first CG element. The AR computing device determines 712, based on the comparison, that the first movement input exceeds a predefined comparison threshold. At 714, the AR computing device causes the AR display device to display an alert on the display surface to alert the viewer based on the determination.

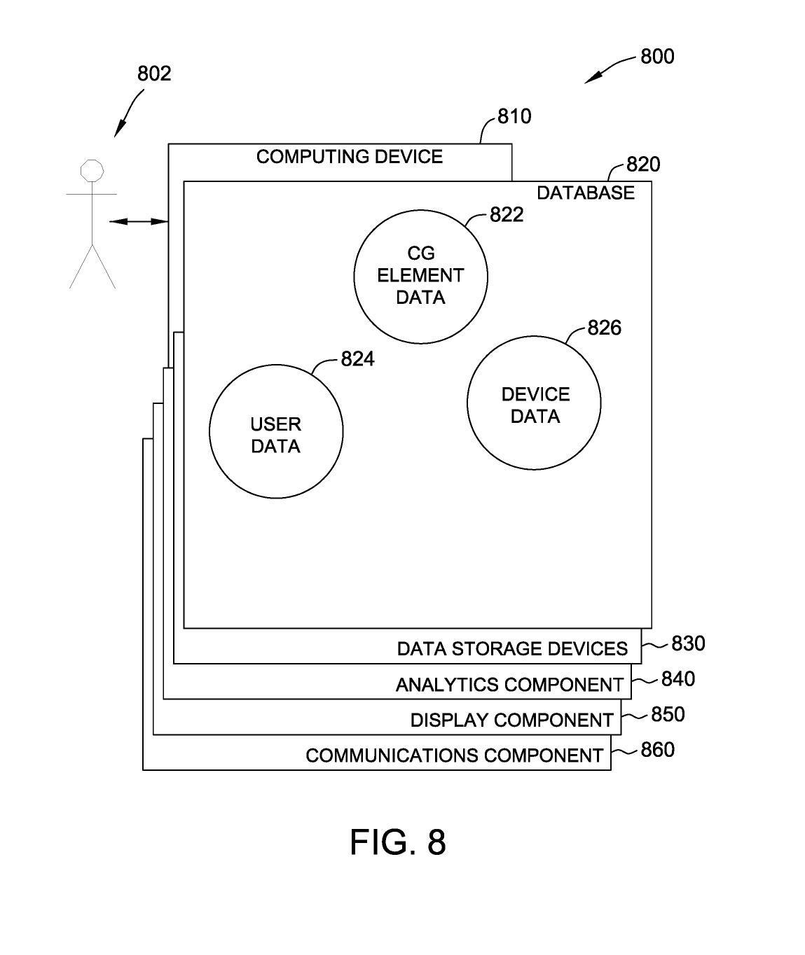

FIG. 8 shows an example configuration of a database 800 within a computer device, along with other related computer components, that may be used to generate CG elements during an AR-based service delivery. In some embodiments, computer device 810 is similar to AR computing device 120 (shown in FIG. 1). Operator 802 (such as a user operating AR computing device 120) may access computer device 810 in order to manage AR-based service delivery for one or more other users (such as the users or viewers described earlier that perform exercise routines based on CG elements generated by AR computing device 120). In some embodiments, database 820 is similar to storage device 134 (shown in FIG. 1). In the example embodiment, database 820 includes CG element data 822, user data 824, and device data 826. CG element data 822 includes data relating to current and prior computer-generated elements (e.g., recorded images of CG elements, resolutions, pixel values, color values, size values, associations with specific users, or the like). User data 824 includes data regarding users that communicate with AR computing device 120 using, for example, AR display device 110. These include user account data, user exercise routines data, CG elements that are “ghosted” from users, and data linkages connecting these data. Device data 826 includes data relating to devices such as AR display devices, camera devices, and AR-capable physical objects with which AR computing device 120 communicates.

Computer device 810 also includes data storage devices 830. Computer device 810 also includes analytics component 840 that assists in generating CG elements. Computer device 810 also includes display component 850 that can be used by operator 802 to view the status of AR computing device 120. Computer device 810 also includes communications component 860 which is used to communicate with remote computer devices (e.g., an AR display device). In one embodiment, communications component 860 is similar to communications interface 225 (shown in FIG. 2).

In some embodiments, a processor included in an AR system, such as a processor associated with an AR computing device and/or AR display device, is configured to implement machine learning, such that the processor “learns” to analyze, organize, and/or process data without being explicitly programmed. Machine learning may be implemented through machine learning (ML) methods and algorithms. In an exemplary embodiment, a machine learning (ML) module associated with a processor is configured to implement ML methods and algorithms. In some embodiments, ML methods and algorithms are applied to data inputs and generate machine learning (ML) outputs. Data inputs may include but are not limited to: AR data, image or video data, location data, CG element data, device data, user hand gestures, user eye movement, other user movements, voice recording, user preferences, user profile data, and transaction data. Data inputs may further include: sensor data, authentication data, authorization data, security data, mobile device data, geolocation information, and/or personal identification data. ML outputs may include but are not limited to: AR data, user gesture and movement recognition, CG element data, and user recognition. ML outputs may further include: speech recognition, image or video recognition, user recommendations and personalization, skill acquisition, and/or information extracted about a computer device, a user, a home, or a party of a transaction. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function which maps outputs to inputs and utilize the predictive function to generate ML outputs based on data inputs. The example inputs and example outputs of the training data may include any of the data inputs or ML outputs described above. For example, a ML module may receive training data including user hand gestures and user eye movements along with an associated desired action, generate a model which maps desired actions to user hand gestures and user eye movement, and generate a ML output including a desired action for subsequently received data inputs including user hand gestures and user eye movement.

In another embodiment, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship. In an exemplary embodiment, a ML module receives unlabeled data including CG element data, device data, user preferences, user profile data, and transaction data. The ML module further employs an unsupervised learning method such as “clustering” to identify patterns and organize the unlabeled data into meaningful groups. The newly organized data may be used, for example, to determine an average time for a training session.

In yet another embodiment, ML methods and algorithms are directed toward reinforcement learning, which involves optimizing outputs based on feedback from a reward signal. Specifically, ML methods and algorithms directed toward reinforcement learning may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In an exemplary embodiment, a ML module implements reinforcement learning in generating alerts or notifications for a user. The ML module may utilize a decision-making model to recommend a certain action to a user and may receive user facial recognition data when the user carries out the recommended action. A reward signal may be generated based on user satisfaction, determined by facial recognition, in response to the recommended action. The ML module may update the decision-making model such that subsequently generated recommended actions are more likely to create user satisfaction.

As will be appreciated based on the foregoing specification, the above-described embodiments of the disclosure may be implemented using computer programming or engineering techniques including computer software, firmware, hardware or any combination or subset thereof, wherein the technical effect is to establish and operate a filesystem-based application network. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An augmented reality (AR) computing device for generating computer-generated (CG) elements using an AR display device operated by a first user, the AR computing device being communicatively coupled to the AR display device and a camera device, the AR computing device configured to:
receive a request from the first user for a first CG element to be displayed on the AR display device, wherein the first CG element is a visual representation of at least one target physical movement;
cause the AR display device to render the first CG element on a display surface of the AR display device;
receive a first movement input from the camera device, the first movement input representing a physical movement of the first user captured by the camera device;
compare the first movement input to the first CG element;
determine, based on the comparison, that the first movement input exceeds a predefined comparison threshold; and
cause the AR display device to display an alert on the display surface to alert the first user based on the determination.

2. The device in accordance with claim 1, further configured to generate the first CG element using at least one programmatic input, the at least one programmatic input encoding the at least one target physical movement.

3. The device in accordance with claim 2, wherein the at least one programmatic input includes mathematical values representing at least one of a number of repetitions in an exercise, a body dimension of the first user, and a target movement parameter.

4. The device in accordance with claim 1, further configured to:
receive a second movement input, wherein the second movement input is received from a second user that is remote from the first user; and
generate the first CG element based on the second movement input.

5. The device in accordance with claim 4, wherein the second movement input occurs at a time before the request from the first user for the first CG element is received.

6. The device in accordance with claim 1, further configured to:
compare the first movement input to the first CG element using one or more image processing techniques, wherein the one or more image processing techniques compare first image data from the first movement input to second image data from the first CG element.

7. The device in accordance with claim 1, further configured to:
cause the AR display device to display additional overlay data, wherein the additional overlay data includes one or more data relating to an account of the first user.

8. The device in accordance with claim 1, further configured to:
cause the camera device to define a viewable zone for the first user, wherein the first CG element is limited to being rendered within the viewable zone as viewed through the AR display device.

9. The device in accordance with claim 1, further configured to:
receive an interaction input from the camera device, the interaction input representing an interaction by the first user with the first CG element resulting from a predefined motion by the first user with respect to the first CG element as captured by the camera device; and
cause the AR display device to render an update to the first CG element based on the interaction input.

10. A method of generating computer-generated (CG) elements using an augmented reality (AR) computing device, the AR computing device being communicatively coupled to a camera device and an AR display device operated by a first user, the method comprising:
receiving a request from the first user for a first CG element to be displayed on the AR display device, wherein the first CG element is a visual representation of at least one target physical movement;
causing the AR display device to render the first CG element on a display surface of the AR display device;
receiving a first movement input from the camera device, the first movement input representing a physical movement of the first user captured by the camera device;
comparing the first movement input to the first CG element;
determining, based on the comparison, that the first movement input exceeds a predefined comparison threshold; and
causing the AR display device to display an alert on the display surface to alert the first user based on the determination.

11. The method in accordance with claim 10, further comprising generating the first CG element using at least one programmatic input, the at least one programmatic input encoding the at least one target physical movement.

12. The method in accordance with claim 11, wherein generating the first CG element using the at least one programmatic input comprises generating the first CG element using at least one mathematical value representing at least one of a number of repetitions in an exercise, a body dimension of the first user, and a target movement parameter.

13. The method in accordance with claim 10, further comprising:
receiving a second movement input, wherein the second movement input is received from a second user that is remote from the first user; and
generating the first CG element based on the second movement input.

14. The method in accordance with claim 13, wherein receiving the second movement input occurs at a time before receiving the request from the first user for the first CG element.

15. The method in accordance with claim 10, further comprising:
comparing the first movement input to the first CG element using one or more image processing techniques, wherein the one or more image processing techniques compare first image data from the first movement input to second image data from the first CG element.

16. A non-transitory computer readable medium that includes computer executable instructions for generating computer-generated (CG) elements using an augmented reality (AR) computing device, the AR computing device communicatively coupled to an AR display device operated by a first user and a camera device, wherein when executed by the AR computing device, the computer executable instructions cause the AR computing device to:
receive a request from the first user for a first CG element to be displayed on the AR display device, wherein the first CG element is a visual representation of at least one target physical movement;
cause the AR display device to render the first CG element on a display surface of the AR display device;
receive a first movement input from the camera device, the first movement input representing a physical movement of the first user captured by the camera device;
compare the first movement input to the first CG element;
determine, based on the comparison, that the first movement input exceeds a predefined comparison threshold; and
cause the AR display device to display an alert on the display surface to alert the first user based on the determination.

17. The non-transitory computer readable medium in accordance with claim 16, wherein the computer executable instructions further cause the AR computing device to generate the first CG element using at least one programmatic input, the at least one programmatic input encoding the at least one target physical movement.

18. The non-transitory computer readable medium in accordance with claim 17, wherein the computer executable instructions further cause the AR computing device using the at least one programmatic input that includes mathematical values representing at least one of a number of repetitions in an exercise, a body dimension of the first user, and a target movement parameter.

19. The non-transitory computer readable medium in accordance with claim 16, wherein the computer executable instructions further cause the AR computing device to:
receive a second movement input, wherein the second movement input is received from a second user that is remote from the first user; and
generate the first CG element based on the second movement input.

20. The non-transitory computer readable medium in accordance with claim 16, wherein the computer executable instructions further cause the AR computing device to compare the first movement input to the first CG element using one or more image processing techniques, wherein the one or more image processing techniques compare first image data from the first movement input to second image data from the first CG element.
